(19) United States
(12) Patent Application Publication
(10) Pub. No.: US 2005/0047508 A1
(43) Pub. Date: Mar. 3, 2005

(54) Adaptive interframe wavelet video coding method, computer readable recording medium and system therefor

(75) Inventors: Ho-jin Ha, Seoul (KR); Chang-hoon Yim, Seoul (KR); Bae-keun Lee, Bucheon-si (KR); Woo-jin Han, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/924,825

(22) Filed: Aug. 25, 2004

Related U.S. Application Data
(60) Provisional application No. 60/497,567, filed on Aug. 26, 2003.

(30) Foreign Application Priority Data
Sep. 23, 2003 (KR) 2003-0065863

(51) Int. Cl. H04N 7/12

(52) U.S. Cl. 375/240.16; 375/240.03; 375/240.19; 375/240.24; 375/240.12

(57) ABSTRACT

An adaptive interframe wavelet video coding method, a computer readable recording medium and system therefor are provided. The interframe wavelet video coding method includes (a) receiving a group-of-frames including a plurality of frames and determining a mode flag according to a predetermined procedure using motion vectors of boundary pixels, (b) temporally decomposing the frames included in the group-of-frames in predetermined directions in accordance with the determined mode flag, and (c) performing spatial transform and quantization on the frames obtained by performing step (b), thereby generating a bitstream. Since an appropriate temporal filtering is performed in accordance with a boundary condition, efficiency of interframe wavelet video coding is increased.

### CROSS-REFERENCE TO RELATED APPLICATIONS

This application claims priority from Korean Patent Application No. 10-2003-0065863 filed on Sep. 23, 2003, with the Korean Intellectual Property Office, and U.S. Provisional Application No. 60/497,567, filed on Aug. 26, 2003, with the United States Patent and Trademark Office, the disclosures of which are incorporated herein in their entirety by reference.

### BACKGROUND OF THE INVENTION

1. Field of the Invention

The present invention relates to a wavelet video coding method, a computer readable recording medium and system therefor, and more particularly, to an interframe wavelet video coding (IWVC) method which decreases an average temporal distance by changing a temporal filtering direction.

2. Description of the Related Art

With the development of information communication technology including the Internet, video communication as well as text and voice communication has increased. Conventional text communication cannot satisfy the various demands of users, and thus multimedia services that can provide various types of information such as text, pictures, and music have increased. Multimedia data requires large capacity storage mediums and wide bandwidths for transmission since the amount of multimedia data is usually large. For example, a 24-bit true color image having a resolution of 640*480 needs a capacity of 640*480*24 bits, i.e., data of about 7.37 Mbits, per frame. When this image is transmitted at a speed of 30 frames per second, a bandwidth of 221 Mbits/sec is required. When a 90-minute movie based on such an image is stored, a storage space of about 1200 Gbits is required. Accordingly, a compression coding method is a requisite for transmitting multimedia data including text, video, and audio.

A basic principle of data compression is removing data redundancy. Data can be compressed by removing spatial redundancy in which the same color or object is repeated in an image, temporal redundancy in which there is little change between adjacent frames in a moving image or the same sound is repeated in audio, or mental visual redundancy taking into account human eyesight and limited perception of high frequency. Data compression can be classified into lossy/lossless compression according to whether source data is lost, intraframe/interframe compression according to whether individual frames are compressed independently, and symmetric/asymmetric compression according to whether time required for compression is the same as time required for recovery. In addition, data compression is defined as real-time compression when a compression/recovery time delay does not exceed 50 ms and as scalable compression when frames have different resolutions. For text or medical data, lossless compression is usually used. For multimedia data, lossy compression is usually used. Meanwhile, intraframe compression is usually used to remove spatial redundancy, and interframe compression is usually used to remove temporal redundancy.

FIG. 1 is a flowchart of a conventional three-dimensional IWVC method.

First, an image is received in group-of-frames (GOF) units in step S1. The GOF includes a plurality of frames, e.g., 16 frames. In IWVC, various operations are performed in GOF units.

Next, motion estimation is performed using hierarchical variable size block matching (HVSBM) in step S2. Referring to FIG. 2, which illustrates a motion estimation using HVSBM, an original image has a size of N*N, images of level 0 (N*N), of level 1 (N/2*N/2), and of level 2 (N/4*N/4) are obtained using wavelet transform. For the image of level 2, a motion estimation block size is changed from 16*16 to 8*8 and 4*4, and a motion estimation (ME) and a Magnitude of Absolute Distortion (MAD) are obtained with respect to each block.

Similarly, for the image of level 1, the motion estimation block size is changed from 32*32 to 16*16, 8*8, and 4*4, and an ME and a MAD are obtained with respect to each block. For the image of level 0, the motion estimation block size is changed from 64*64 to 32*32, 16*16, 8*8, and 4*4, and an ME and a MAD are obtained with respect to each block.

Next, as shown in FIG. 1, an ME tree is pruned to minimize the MAD in step S3.

Motion compensated temporal filtering (MCTF) is performed using a pruned optimal ME in step S4. Referring to FIG. 3, at temporal level 0, MCTF is performed forward with respect to 16 image frames, thereby obtaining 8 low-frequency frames and 8 high-frequency frames. At temporal level 1, MCTF is performed forward with respect to the 8 low-frequency frames, thereby obtaining 4 low-frequency frames and 4 high-frequency frames. At temporal level 2, MCTF is performed forward with respect to the 4 low-frequency frames obtained at temporal level 1, thereby obtaining 2 low-frequency frames and 2 high-frequency frames. Lastly, at temporal level 3, MCTF is performed forward with respect to the 2 low-frequency frames obtained at temporal level 2, thereby obtaining a single low-frequency frame and a single high-frequency frame. Accordingly, as a result of MCTF, a total of 16 subbands H1, H3, H5, H7, H9, H10, H13, H15, LH2, LH6, LH10, LH14, LLH4, LLH12, LLLH8, and LLLL16 including 15 high-frequency frames and a single low-frequency frame at the last level are obtained.

After obtaining the 16 subbands, spatial transform and quantization are performed on the 16 subbands in step S5. Thereafter, a bitstream including data obtained by performing spatial transform and quantization on the 16 subbands, motion estimation data, and a header is generated in step S6.

Although such conventional IWVC has excellent scalability, it does not have satisfactory performance as compared to other conventional video coding methods. An example of IWVC performance depending upon a boundary condition will be described with reference to FIGS. 4A and 4B.

FIGS. 4A and 4B are diagrams comparing performances of conventional MCTF with respect to a boundary condition.

FIG. 4A illustrates a best case of forward MCTF where an external image comes into a frame while FIG. 4B illustrates a worst case of forward MCTF where an internal image goes out of the frame. Where MCTF is performed forward, a temporally preceding image is replaced with a filtered high-frequency image, and a temporally succeeding image is replaced with a filtered low-frequency image. For video coding, high-frequency frames and a single low-frequency frame at a highest level are used. In other words, performance of video coding depends on whether a component of a high-frequency frame is large or small.

In a case where the external image comes into the frame, a T-1 frame is replaced with a high-frequency image, and a T frame is replaced with a low-frequency image. All image blocks in the T-1 frame can be exactly matched with image blocks, respectively, in the T-frame, and thus a magnitude of a high frequency component proportional to a difference between two image blocks is less compared to a case where the image blocks are not matched exactly. In other words, a size of the T-1 frame to be replaced with a high-frequency image is small.

Conversely, in the worst case where the internal image goes out of the frame, all of the image blocks in the T-1 frame are not exactly matched with the image blocks in the T-frame. Here, image blocks A and N that do not have their matches are coupled with image blocks B and M, respectively, giving a least difference therebetween. Since a difference between the image blocks A and B and a difference between the image blocks N and M are needed to be expressed, the size of the T-1 frame is increased.

As described above, performance of MCTF greatly changes depending on a boundary condition such as an incoming image or an outgoing image. Therefore, a video coding method allowing a filtering direction to be adaptively changed according to a boundary condition during MCTF is desired.

### SUMMARY OF THE INVENTION

The present invention provides an adaptive interframe wavelet video coding (IWVC) method allowing a direction of temporal filtering to be changed according to a boundary condition.

The present invention also provides a computer readable recording medium and a system which can perform the adaptive IWVC method.

According to an aspect of the present invention, there is provided an IWVC method comprising, (a) receiving a group-of-frames including a plurality of frames and determining a mode flag according to a predetermined procedure using motion vectors of boundary pixels; (b) temporally decomposing the frames included in the group-of-frames in predetermined directions in accordance with the determined mode flag; and (c) performing spatial transform and quantization on the frames obtained by performing step (b), thereby generating a bitstream.

Preferably, in step (a), the group-of-frames comprises 16 frames. Step (a) may comprise determining the mode flag according to the predetermined procedure using motion vectors obtained at a boundary having a predetermined thickness among motion vectors of pixels obtained through motion estimation using hierarchical variable size block matching (HVSBM). Meanwhile, the motion vectors used to determine the mode flag may be motion vectors of pixels at left and right boundaries, or motion vectors of pixels at left, right, upper and lower boundaries. In the first case, the mode flag F is preferably determined using the following algorithm:

if (abs(L)<Threshold)then L=0

if (abs(R)<Threshold)then R=0
if((L<0 and R==0)or (L==0 and R>0)or (L<0 and R>0))then F=0
else if((L>0 and R==0)or (L==0 and R <0)or (L>0 and R<0))then F=1
else F=2,

where, L denotes an average of X components of motion vectors of pixels at the left boundary having the predetermined thickness, and R denotes an average of X components of motion vectors of pixels at the right boundary having the predetermined thickness,

wherein step (b) comprises temporally decomposing the frames included in the group-of-frames in a forward direction when F=0, temporally decomposing the frames included in the group-of-frames in a backward direction when F=1, and temporally decomposing the frames included in the group-of-frames in forward and backward directions combined in a predetermined sequence when F=2. In the latter case, the mode flag F is preferably determined using the following algorithm:

if (abs(L)<Threshold)then L=0

if (abs(R)<Threshold)then R=0

if (abs(U)<Threshold)then U=0

if (abs(D)<Threshold)then D=0
if(((L<0 and R==0)or (L==0 and R>0)or (L<0 and R>0))and ((D<0 and U==0)or (D==0 and U>0)or (D<0 and U>0)or (D==0 and U==0)))then F=0
else if(((L>0 and R==0)or (L==0 and R<0)or (L>0 and R<0))and ((D>0 and U==0) or (D==0 and U<0)or (D>0 and U<0)or (D==0 and U==0)))then F=1
else F=2

where L denotes an average of X components of motion vectors of pixels at the left boundary having the predetermined thickness, R denotes an average of X components of motion vectors of pixels at the right boundary having the predetermined thickness, U denotes an average of Y components of motion vectors of pixels at the upper boundary having the predetermined thickness, and D denotes an average of Y components of motion vectors of pixels at the lower boundary having the predetermined thickness,

wherein step (b) comprises temporally decomposing the frames included in the group-of-frames in a forward direction when F=0, temporally decomposing the frames included in the group-of-frames in a backward direction when F=1, and temporally decomposing the frames included in the group-of-frames in forward and backward directions combined in a predetermined sequence when F=2.

In either case, when F=2 in step (b), the frames are preferably decomposed such that an average temporal distance between frames is minimized.

Programs executing the adaptive IWVC method may be recorded onto a computer readable recording medium to be used in a computer.

According to another aspect of the present invention, there is provided an IWVC system which receives a group-of-frames including a plurality of frames and generates a bitstream. The IWVC system comprises a motion estimation/mode determination block which receives the group-of-frames, obtains motion vectors of pixels in each of the frames using a predetermined procedure, and determines a mode flag using motion vectors of boundary pixels among the obtained motion vectors; and a motion compensation temporal filtering block which decomposes the frames into low- and high-frequency frames in a predetermined temporal direction in accordance with the mode flag determined by the motion estimation/mode determination block using the motion vectors.

The interframe wavelet video coding system may further comprise a spatial transform block which wavelet-decomposes the low- and high-frequency frames generated by the motion compensation temporal filtering block into spatial low- and high-frequency components.

### BRIEF DESCRIPTION OF THE DRAWINGS

The above and other features and advantages of the present invention will become more apparent by describing in detail exemplary embodiments thereof with reference to the attached drawings in which:

FIG. 1 is a flowchart of a conventional three-dimensional interframe wavelet video coding (IWVC) method;

FIG. 2 illustrates conventional motion estimation using hierarchical variable size block matching (HVSBM);

FIG. 3 illustrates conventional motion compensated temporal filtering (MCTF);

FIGS. 4A and 4B are diagrams comparing performances of conventional MCTF with respect to a boundary condition;

FIG. 5 is a flowchart of an adaptive IWVC method according to an embodiment of the present invention;

FIGS. 6A and 6B illustrate a reference for determining an MCTF direction according to a boundary condition;

FIGS. 7A and 7B illustrate boundary pixels used to determine a mode flag;

FIG. 8 illustrates MCTF directions according to a mode flag representing a boundary condition; and

FIG. 9 is a functional block diagram of a system for adaptive IWVC according to an embodiment of the present invention.

### DETAILED DESCRIPTION OF THE INVENTION

Exemplary, non-limiting, embodiments of the present invention will now be described with reference to the accompanying drawings.

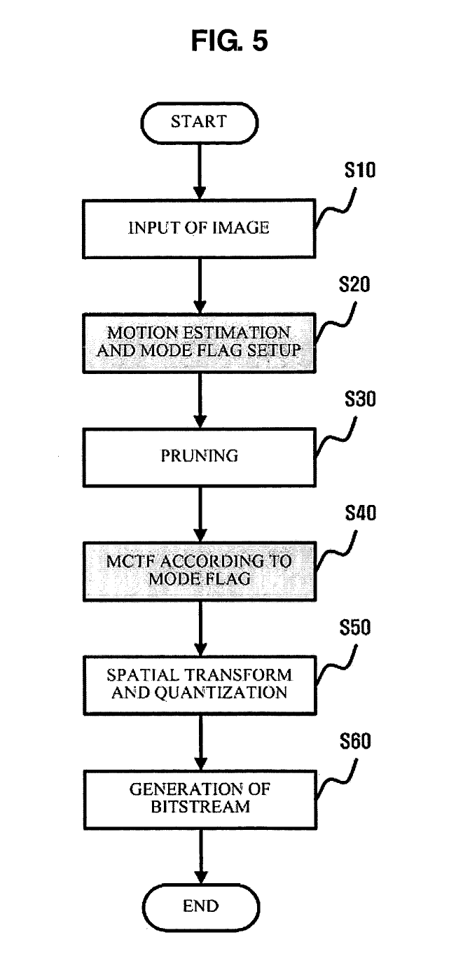

FIG. 5 is a flowchart of an adaptive interframe wavelet video coding (IWVC) method according to an embodiment of the present invention.

An image is received in group-of-frames (GOF) units in step S10. A single GOF includes a plurality of frames and preferably includes 2ⁿ frames (where “n” is a natural number), e.g., 2, 4, 8, 16, or 32 frames, to facilitate computation and management. When the number of frames included in a GOF increases, video coding efficiency increases while buffering time and coding time also increases unfavorably. As the number of frames included in a GOF decreases, video coding efficiency decreases. In the embodiment of the present invention, a single GOF includes 16 frames.

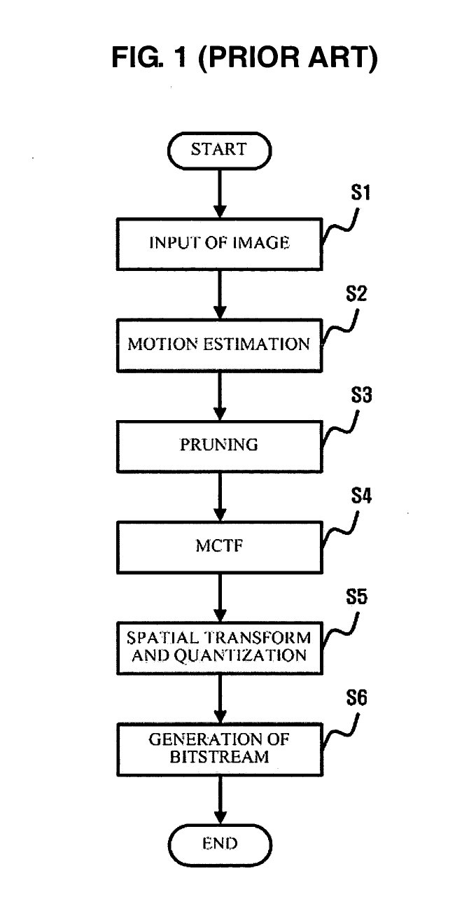

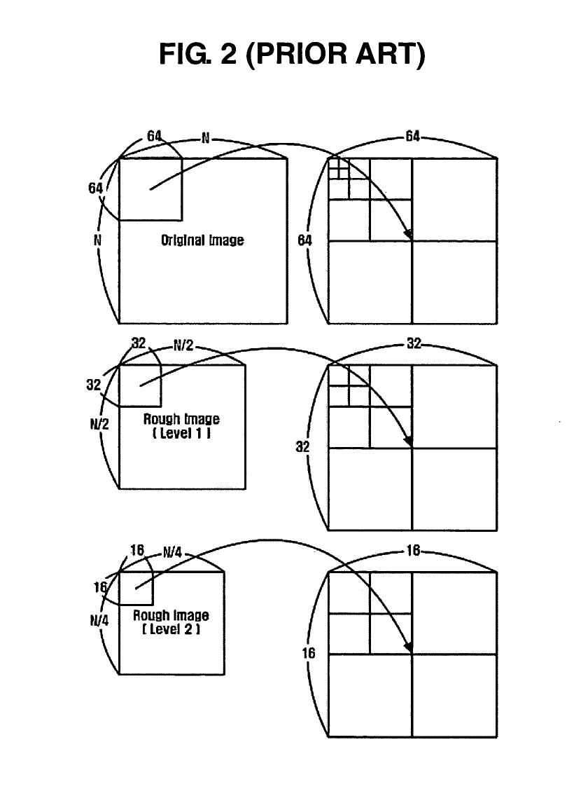

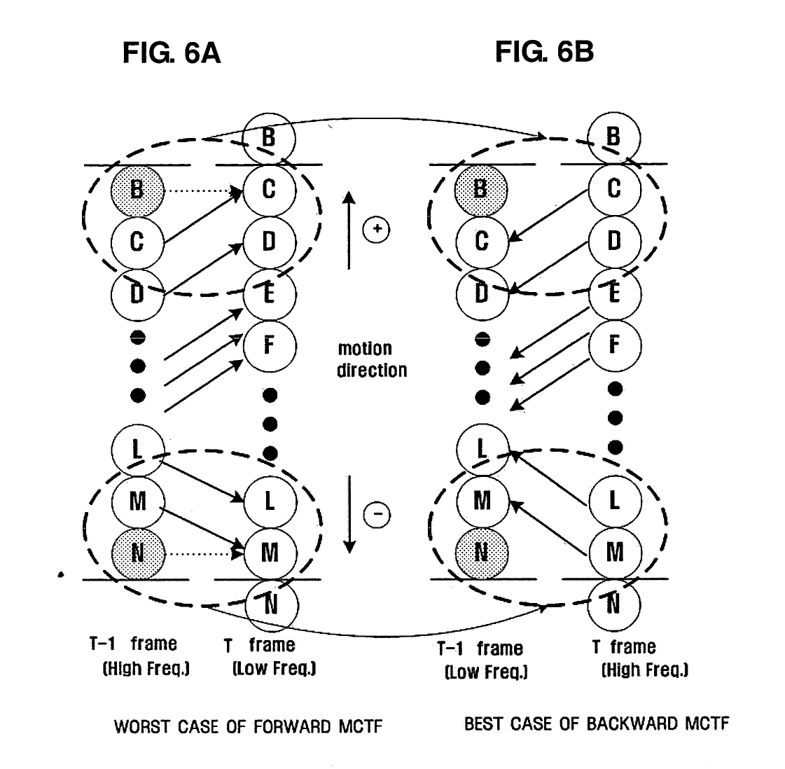

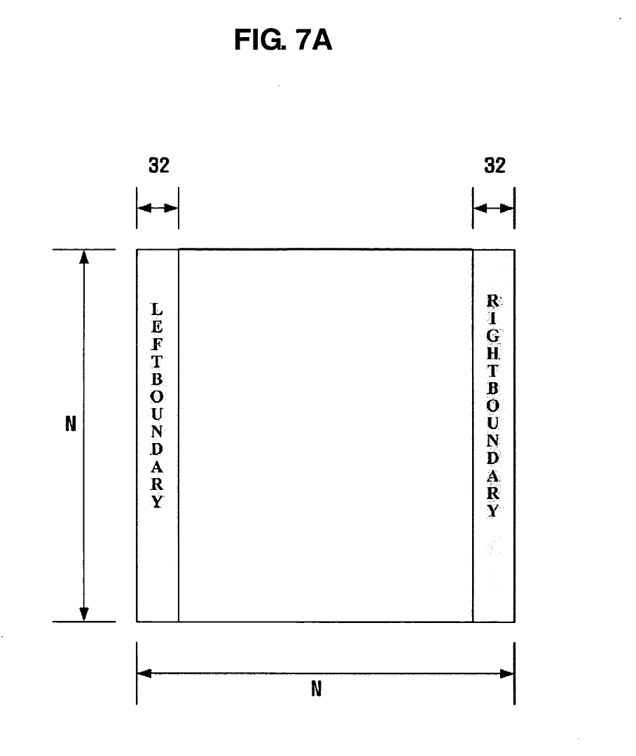

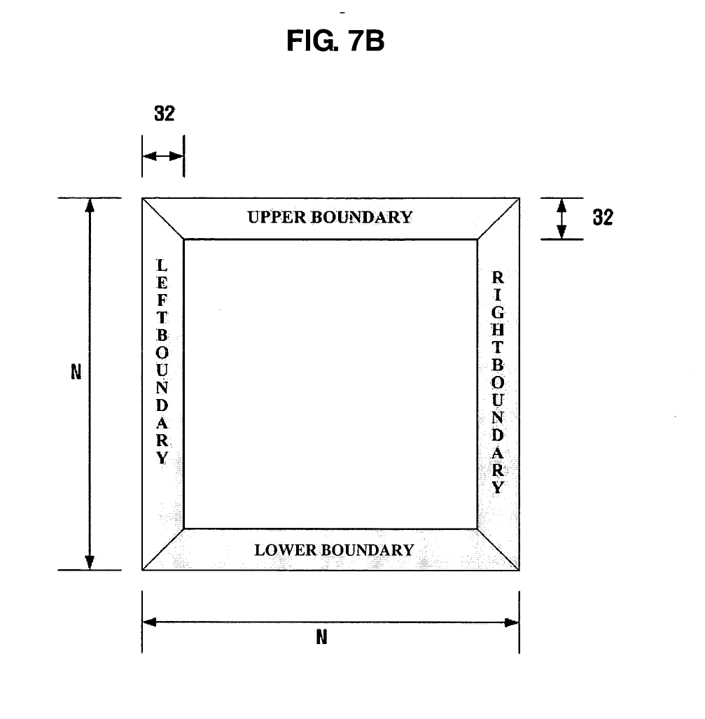

After receiving the image, motion estimation is performed and a mode flag is set in step S20. Preferably, the motion estimation is performed using hierarchical variable size block matching (HVSBM) as described with reference to FIG. 1. The mode flag is used to determine a direction of temporal filtering according to a boundary condition. A reference for determining a mode flag will be described with reference to FIGS. 6A, 6B, 7A and 7B.

After the motion estimation and mode flag setup, pruning is performed in the same manner as in conventional technology in step S30.

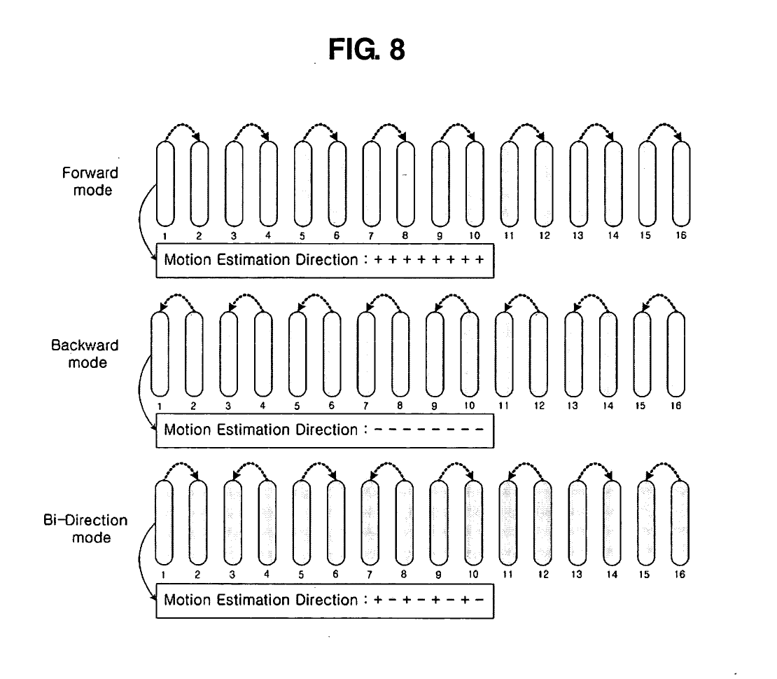

Next, motion compensated temporal filtering (MCTF) is performed using a pruned motion vector in step S40. An MCTF direction in accordance with the mode flag will be described with reference to FIG. 8.

After completing the MCTF, 16 subbands resulting from the MCTF are subjected to spatial transform and quantization in step S50. Thereafter, a bitstream including data resulting from the spatial transform and quantization, motion vector data, and the mode flag is generated in step S60.

FIGS. 6A and 6B illustrate a reference for determining an MCTF direction according to a boundary condition, and FIGS. 7A and 7B illustrate boundary pixels used to determine a mode flag.

FIGS. 6A and 6B illustrate cases where an internal image goes out of the frame. FIG. 6A illustrates forward MCTF, and FIG. 6B illustrates backward MCTF. In other words, image blocks B and N flow out of the frame when a T-1 frame is converted into a T frame. In the worst case of forward MCTF shown in FIG. 6A, the image blocks B and N in the T-1 frame do not have their matches in the T frame. Thus, the image blocks B and N in the T-1 frame are compared with image blocks C and M, respectively, in the T frame. In this situation, a difference between the image blocks B and C and a difference between the image blocks N and M are large, which increases the amount of information of the T-1 frame to be replaced with a high-frequency frame. Conversely, in the best case of backward MCTF shown in FIG. 6B, each image block in the T frame to be replaced with a high-frequency frame has its matches in the T-1 frame, and therefore, the amount of information of the high-frequency frame, i.e., the T frame, may be decreased.

In a comprehensive conception, forward MCTF is more efficient in a case where a new image comes into a frame through a boundary while backward MCTF is more efficient in a case where an image goes out of the frame through a boundary. In other cases, it is efficient to properly combine forward MCTF and backward MCTF. In other words, video coding efficiency and performance can be increased by properly selecting either forward or backward MCTF according to a boundary condition of an input GOF. In setting a mode flag, a basic principle is made that forward MCTF is used when a new image comes into a frame, backward MCTF is used when an image goes out of a frame, and forward MCTF and backward MCTF are properly combined in other cases.

The mode flag can be determined using a motion vector for pixels at a boundary of a frame. As shown in FIG. 7A, pixels at right and left boundaries of a frame may be used in a first embodiment. Alternatively, as shown in FIG. 7B, pixels at right, left, upper, and lower boundaries of a frame may be used in a second embodiment. Video coding performance depends on a thickness of a boundary used to determine the mode flag. Where the boundary is too thin, information regarding output/input of a particular image may be missed. Conversely, where the boundary is too thick, a boundary condition may not be sharply identified. Accordingly, the thickness of the boundary needs to be appropriately determined. In embodiments of the present invention, the boundary has a thickness of 32 pixels.

In determining the mode flag, motion vectors of pixels in each frames are obtained using HVSBM. A mode flag is determined based on the motion vectors of pixels in the frames. The mode flag may be different according to a temporal level, but it is preferable to determine the mode flag at temporal level 0.

In the first embodiment shown in FIG. 7A, a mode flag is determined using motion vectors at left and right boundaries of each frame because a new image usually comes into or goes out of a frame of a moving picture in an X direction. An average of motion vectors of pixels at the left boundary of each of all frames included in a single GOF is obtained. An X component of the average motion vector at the left boundary is denoted by “L.” Similarly, an average of motion vectors of pixels at the right boundary of each of all frames included in a single GOF is obtained. An X component of the average motion vector at the right boundary is denoted by “R.” Where an L value less than 0 indicates that an image comes into the frame through the left boundary, an R value less than 0 indicates that an image goes out of the frame through the right boundary. Similarly, the L value greater than 0 and the R value greater than 0 account for the opposite cases, respectively. Actually, the L or R value may not be 0 even if an image does not come in or go out of the frame. Accordingly, it is preferable that the L and R values not exceeding a predetermined threshold are determined as 0. When an image comes into the frame through the left or right boundary, the L value is less than 0 and the R value is equal to or greater than 0, or the L value is less than 0 and the R value is greater than 0. In this case, it is preferable to use forward MCTF. Conversely, when an image goes out of the frame through the left or right boundary, the L value is greater than 0 and the R value is equal to or less than 0, or the L value is greater than 0 and the R value is less than 0. In this case, it is preferable to use backward MCTF. When an image comes into the frame through the left boundary and an image goes out of the frame through the right boundary, it is preferable to appropriately combine forward MCTF and backward MCTF.

As such, a mode flag F can be determined by the following algorithm:

if (abs(L)<Threshold)then L=0

if (abs(R)<Threshold)then R=0
if((L<0 and R==0)or (L==0 and R>0)or (L<0 and R>0))then F=0
else if((L>0 and R==0)or (L==0 and R <0)or (L>0 and R<0))then F=1
else F=2.

Here, F=0 indicates a forward mode, F=1 indicates a backward mode, and F=2 indicates a bi-directional mode.

In a second embodiment shown in FIG. 7B, left, right, upper, and lower boundaries are used. L and R values are obtained in the same manner as described in the first embodiment, and U and D values are obtained using averages of Y components of motion vectors. Like the first embodiment, where an image comes into a frame through at least one boundary and an image does not go out of the frame through any of the boundaries, it is preferable to use forward MCTF. Where an image goes out of the frame through at least one boundary and an image does not come into the frame through any of the boundaries, it is preferable to use backward MCTF. In other cases, it is preferable to appropriately combine forward MCTF and backward MCTF.

As such, a mode flag F can be determined by the following algorithm:

if (abs(L)<Threshold)then L=0

if (abs(R)<Threshold)then R=0

if (abs(U)<Threshold)then U=0

if (abs(D)<Threshold)then D=0
if(((L<0 and R==0)or (L==0 and R>0)or (L<0 and R>0))and ((D<0 and U==0)or (D==0 and U>0)or (D<0 and U>0)or (D==0 and U==0)))then F=0
else if(((L>0 and R==0)or (L==0 and R<0)or (L>0 and R<0))and ((D>0 and U==0)or (D==0 and U<0)or (D>0 and U<0)or (D==0 and U==0)))then F=1
else F=2.

Here, F=0 indicates a forward mode, F=1 indicates a backward mode, and F=2 indicates a bi-directional mode. The first and second embodiments are exemplary, and the spirit of the present invention is not restricted thereto. In other words, a direction of MCTF is appropriately determined using information regarding image input/output at a boundary. Accordingly, the present invention will be considered as including a case where a mode flag is determined to be different among two or some frames more than two in a GOF in addition to the first and second embodiments where a mode flag is determined using average motion vectors obtained with respect to all of the frames in a GOF.

FIG. 8 illustrates MCTF directions according to a mode flag representing a boundary condition.

In a forward mode, MCTF directions are depicted as ++++++++. In a backward mode, MCTF directions are depicted as −−−−−−−−. In a bi-directional mode, MCTF directions may be depicted in various ways, but FIG. 8 illustrates an example where MCTF directions are depicted as +−+−+−+− at temporal level 0. Here, “+” indicates a forward direction, and “−” indicates a backward direction.

In each of the forward and backward modes, MCTF is performed in the same direction. However, in the bi-directional mode, video coding performance changes depending on a combination of forward and backward directions. In other words, in the bi-directional mode, a sequence of forward and backward directions may be determined in various ways. Representative examples of a sequence of MCTF directions in the forward, backward, and bi-directional modes are shown in Table 1.

TABLE 1

| Mode flag | | Level 0 | Level 1 | Level 2 | Level 3 |
|---|---|---|---|---|---|
| Forward direction | | ++++++++ | ++++ | ++ | + |
| (F = 0) | | | | | |
| Backward direction | | − − − − − − − − | − − − − | − − | − |
| (F = 1) | | | | | |
| Bi-direction(F = 2) | a | + − + − + − + − | ++− − | + − | +(−) |
| | b | + − + − + − + − | + −+− | + − | +(−) |
| | c | ++++++++ | ++− − | + − | − |
| | d | ++++ − − − − | ++ − − | + − | − |

Various combinations of forward and backward directions may be made in the bi-directional mode, but four cases “a”, “b”, “c”, and “d” are shown as examples. The cases “c” and “d” are characterized in that a low-frequency frame (hereinafter, referred to as a reference frame) at a last level is positioned at a center (i.e., an 8th frame) among 1st through 16th frames. The reference frame is a most essential frame in video coding. The other frames are recovered based on the reference frame. As a temporal distance between a frame and the reference frame increases, recovery performance decreases. Accordingly, in the cases “c” and “d”, a combination of forward MCTF and backward MCTF is made such that the reference frame is positioned at the center, i.e., the 8th frame, to minimize a temporal distance between the reference frame and each of the other frames.

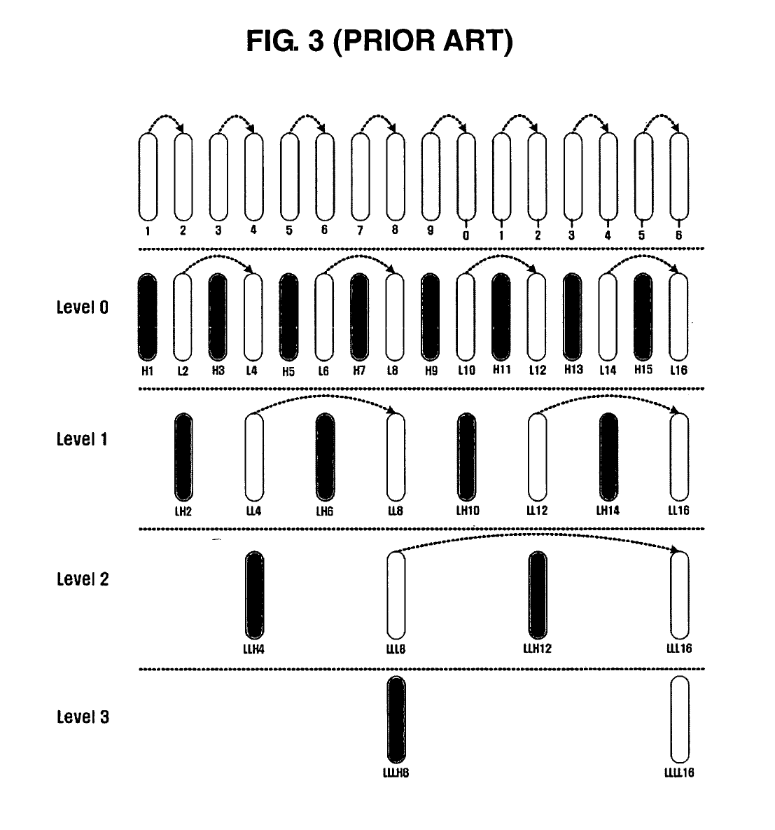

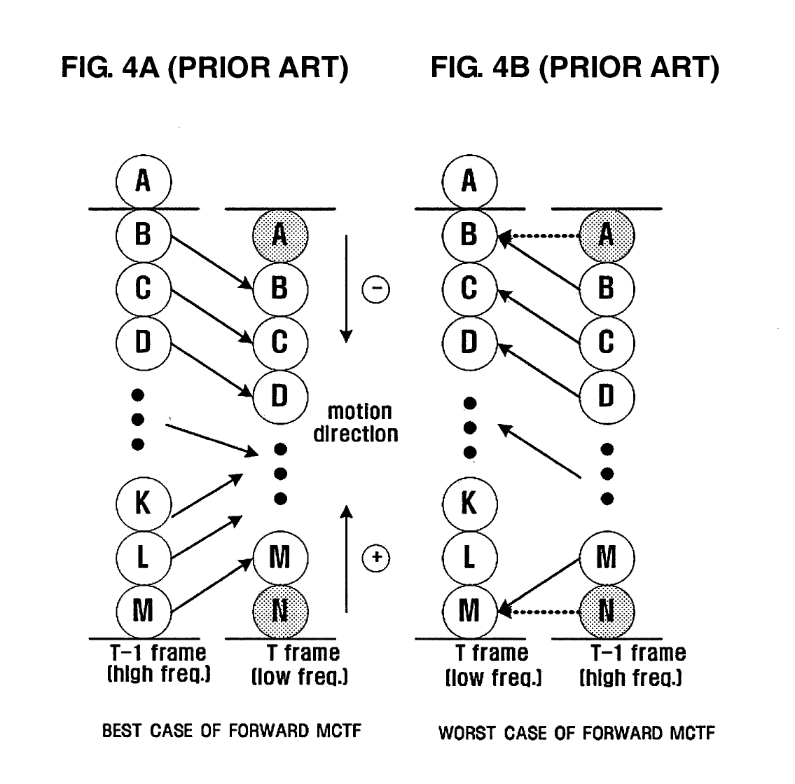

In the cases “a” and “b”, an average temporal distance (ATD) is minimized. To calculate an ATD, temporal distances are calculated. A temporal distance is defined as a positional difference between two frames. Referring to FIG. 3, a temporal distance between a first frame and a second frame is defined as 1, and a temporal distance between the frame L2 and the frame L4 is defined as 2. An ATD is obtained by dividing the sum of temporal distances between frames subjected to an operation for motion estimation in pairs by the number of pairs of frames defined for the motion estimation. In the case “a”,

$$ATD = \frac{8 \times 1 + 4 \times 1 + 2 \times 4 + 1 \times 3}{15} = 1.53 .$$

In the case “b”,

$$ATD = \frac{8 \times 1 + 4 \times 1 + 2 \times 4 + 1 \times 3}{15} = 1.53 .$$

In the forward mode and the backward mode shown in Table 1,

$$ATD = \frac{8 \times 1 + 4 \times 2 + 2 \times 4 + 1 \times 8}{15} = 2.13 .$$

In the case “c”,

$$ATD = \frac{8 \times 1 + 4 \times 2 + 2 \times 4 + 1 \times 2}{15} = 1.73 . In$$

the case “d”,

$$ATD = \frac{8 \times 1 + 4 \times 1 + 2 \times 4 + 1 \times 1}{15} 1.67 .$$

In actual simulations, as an ATD was decreased, a PSNR value was increased so that performance of video coding was increased.

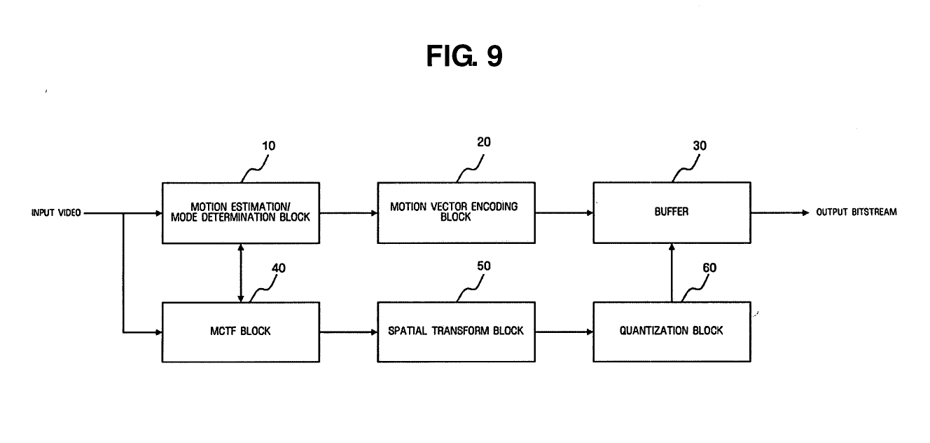

FIG. 9 is a functional block diagram of a system for adaptive IWVC according to an embodiment of the present invention.

The system for adaptive IWVC includes a motion estimation/mode determination block 10 which obtains a motion vector and determines a mode using the motion vector, a motion compensation temporal filtering block 40 which removes temporal redundancy using the motion vector and the determined mode, a spatial transform block 50 which removes spatial redundancy, a motion vector encoding block 20 which encodes the motion vector using a predetermined algorithm, a quantization block 60 which quantizes wavelet coefficients of respective components generated by the spatial transform block 50, and a buffer 30 which temporarily stores an encoded bitstream received from the quantization block 60.

The motion estimation/mode determination block 10 obtains a motion vector used by the motion compensation temporal filtering block 40 using a hierarchical method such as HVSBM. In addition, the motion estimation/mode determination block 10 determines a mode flag for determining temporal filtering directions.

The motion compensation temporal filtering block 40 decomposes frames into low-and high-frequency frames in a temporal direction using the motion vector obtained by the motion estimation/mode determination block 10. A direction of the decomposition is determined according to the mode flag. Frames are decomposed in GOF units. Through such decomposition, temporal redundancy is removed.

The spatial transform block 50 wavelet-decomposes frames that have been decomposed in the temporal direction by the motion compensation temporal filtering block 40 into spatial low- and high-frequency components, thereby removing spatial redundancy.

The motion vector encoding block 20 encodes the motion vector and the mode flag hierarchically obtained by the motion estimation/mode determination block 10 and then transmits the encoded motion vector and the encoded mode flag to the buffer 30.

The quantization block 60 quantizes and encodes wavelet coefficients of components generated by the spatial transform block 50.

The buffer 30 stores a bitstream including encoded data, the encoded motion vector, and the encoded mode flag before transmission and is controlled by a rate control algorithm.

It will be understood by those of ordinary skill in the art that various changes in form and details may be made therein without departing from the spirit and scope of the present invention as defined by the following claims. Therefore, it is to be appreciated that the above described embodiment is for purposes of illustration only and not to be construed as a limitation of the invention. The scope of the invention is given by the appended claims, rather than the preceding description, and all variations and equivalents which fall within the range of the claims are intended to be embraced therein.

According to the present invention, IWVC can be adaptively performed in accordance with a boundary condition. In other words, as compared to conventional methods, a PSNR is increased in the present invention. In experiments, performance was increased by about 0.8 dB. In the experiments, Mobile, Tempete, Canoa, and Bus were used, and results of the experiments are shown in Tables 2 through 5.

TABLE 2
Mobile, CIF, Frames: 0-299

| Bit rate | Forward direction | Backward direction |
|---|---|---|
| 400 | 26.1 | 26.2 |
| 600 | 28.0 | 28.0 |
| 800 | 29.3 | 29.2 |

TABLE 3
Tempete CIF, Frames: 0-259

| Bit rate | Forward direction | Backward direction |
|---|---|---|
| 400 | 29.2 | 29.2 |
| 600 | 30.7 | 30.7 |
| 800 | 31.8 | 31.8 |

TABLE 4
Canoa, CIF, Frames: 0-208

| Bit rate | Forward direction | Backward direction |
|---|---|---|
| 400 | 23.3 | 24.8 |
| 600 | 25.2 | 26.2 |
| 800 | 26.2 | 27.2 |

TABLE 5
Bus, CIF, Frames: 0-150

| Bit rate | Forward direction | Backward direction |
|---|---|---|
| 400 | 25.5 | 26.5 |
| 600 | 27.3 | 28.2 |
| 800 | 28.6 | 29.4 |

1. An interframe wavelet video coding method comprising:
(a) receiving a group-of-frames including a plurality of frames and determining a mode flag according to a predetermined procedure using motion vectors of boundary pixels;
(b) temporally decomposing the frames included in the group-of-frames in predetermined directions in accordance with the determined mode flag; and
(c) performing spatial transform and quantization on the frames obtained by performing step (b), thereby generating a bitstream.

2. The interframe wavelet video coding method of claim 1, wherein in step (a), the group-of-frames comprises 16 frames.

3. The interframe wavelet video coding method of claim 1, wherein step (a) comprises determining the mode flag according to the predetermined procedure using motion vectors obtained at a boundary having a predetermined thickness among motion vectors of pixels obtained through motion estimation using hierarchical variable size block matching (HVSBM).

4. The interframe wavelet video coding method of claim 3, wherein the motion vectors used to determine the mode flag are motion vectors of pixels at left and right boundaries.

5. The interframe wavelet video coding method of claim 4, wherein the mode flag F is determined using the following algorithm:
if (abs(L)<Threshold)then L=0
if (abs(R)<Threshold)then R=0
if((L<0 and R==0)or (L==0 and R>0)or (L<0 and R>0))then F=0
else if((L>0 and R==0)or (L==0 and R<0)or (L>0 and R<0))then F=1
else F=2,
where, L denotes an average of X components of motion vectors of pixels at the left boundary having the predetermined thickness, and R denotes an average of X components of motion vectors of pixels at the right boundary having the predetermined thickness,
wherein step (b) comprises temporally decomposing the frames included in the group-of-frames in a forward direction when F=0, temporally decomposing the frames included in the group-of-frames in a backward direction when F=1, and temporally decomposing the frames included in the group-of-frames in forward and backward directions combined in a predetermined sequence when F=2.

6. The interframe wavelet video coding method of claim 5, wherein when F=2 in step (b), the frames are decomposed such that an average temporal distance between frames is minimized.

7. The interframe wavelet video coding method of claim 3, wherein the motion vectors used to determine the mode flag are motion vectors of pixels at left, right, upper, and lower boundaries.

8. The interframe wavelet video coding method of claim 7, wherein the mode flag F is determined using the following algorithm:
if (abs(L)<Threshold)then L=0
if (abs(R)<Threshold)then R=0
if (abs(U)<Threshold)then U=0
if (abs(D)<Threshold)then D=0
if(((L<0 and R==0)or (L==0 and R>0)or (L<0 and R>0))and ((D<0 and U==0)or (D==0 and U>0)or (D<0 and U>0)or (D==0 and U==0)))then F=0
else if(((L>0 and R==0)or (L==0 and R<0)or (L>0 and R<0))and ((D>0 and U==0) or (D==0 and U<0)or (D>0 and U<0)or (D==0 and U==0)))then F=1
else F=2
where L denotes an average of X components of motion vectors of pixels at the left boundary having the predetermined thickness, R denotes an average of X components of motion vectors of pixels at the right boundary having the predetermined thickness, U denotes an average of Y components of motion vectors of pixels at the upper boundary having the predetermined thickness, and D denotes an average of Y components of motion vectors of pixels at the lower boundary having the predetermined thickness,
wherein step (b) comprises temporally decomposing the frames included in the group-of-frames in a forward direction when F=0, temporally decomposing the frames included in the group-of-frames in a backward direction when F=1, and temporally decomposing the frames included in the group-of-frames in forward and backward directions combined in a predetermined sequence when F=2.

9. The interframe wavelet video coding method of claim 8, wherein when F=2 in step (b), the frames are decomposed such that an average temporal distance between frames is minimized.

10. A recording medium comprising commands which can be executed in a computer, the commands executing:
(a) receiving a group-of-frames including a plurality of frames and determining a mode flag according to a predetermined procedure using motion vectors of boundary pixels;
(b) temporally decomposing the frames included in the group-of-frames in predetermined directions in accordance with the determined mode flag; and
(c) performing spatial transform and quantization on the frames obtained by performing step (b), thereby generating a bitstream.

11. The recording medium of claim 10, wherein in step (a), the group-of-frames comprises 16 frames.

12. The recording medium of claim 9, wherein step (a) comprises determining the mode flag according to the predetermined procedure using motion vectors obtained at a boundary having a predetermined thickness among motion vectors of pixels obtained through motion estimation using hierarchical variable size block matching (HVSBM).

13. The recording medium of claim 12, wherein the motion vectors used to determine the mode flag are motion vectors of pixels at left and right boundaries.

14. The recording medium of claim 13, wherein the mode flag F is determined using the following algorithm:
if (abs(L)<Threshold)then L=0
if (abs(R)<Threshold)then R=0
if((L<0 and R==0)or (L==0 and R>0)or (L<0 and R>0))then F=0
else if((L>0 and R==0)or (L==0 and R<0)or (L>0 and R<0))then F=1
else F=2,
where, L denotes an average of X components of motion vectors of pixels at the left boundary having the predetermined thickness, and R denotes an average of X components of motion vectors of pixels at the right boundary having the predetermined thickness,
wherein step (b) comprises temporally decomposing the frames included in the group-of-frames in a forward direction when F=0, temporally decomposing the frames included in the group-of-frames in a backward direction when F=1, and temporally decomposing the frames included in the group-of-frames in forward and backward directions combined in a predetermined sequence when F=2.

15. The recording medium of claim 14, wherein when F=2 in step (b), the frames are decomposed such that an average temporal distance between frames is minimized.

16. The recording medium of claim 12, wherein the motion vectors used to determine the mode flag are motion vectors of pixels at left, right, upper, and lower boundaries.

17. The recording medium of claim 16, wherein the mode flag F is determined using the following algorithm:
if (abs(L)<Threshold)then L=0
if (abs(R)<Threshold)then R=0
if (abs(U)<Threshold)then U=0
if (abs(D)<Threshold)then D=0
if(((L<0 and R==0)or (L==0 and R>0)or (L<0 and R>0))and ((D<0 and U==0)or (D==0 and U>0)or (D<0 and U>0)or (D==0 and U==0)))then F=0
else if(((L>0 and R==0)or (L==0 and R<0)or (L>0 and R<0))and (D>0 and U==0) or (D==0 and U<0)or (D>0 and U<0)or (D==0 and U==0)))then F=1
else F=2
where L denotes an average of X components of motion vectors of pixels at the left boundary having the predetermined thickness, R denotes an average of X components of motion vectors of pixels at the right boundary having the predetermined thickness, U denotes an average of Y components of motion vectors of pixels at the upper boundary having the predetermined thickness, and D denotes an average of Y components of motion vectors of pixels at the lower boundary having the predetermined thickness,
wherein step (b) comprises temporally decomposing the frames included in the group-of-frames in a forward direction when F=0, temporally decomposing the frames included in the group-of-frames in a backward direction when F=1, and temporally decomposing the frames included in the group-of-frames in forward and backward directions combined in a predetermined sequence when F=2.

18. The recording medium of claim 17, wherein when F=2 in step (b), the frames are decomposed such that an average temporal distance between frames is minimized.

19. An interframe wavelet video coding system which receives a group-of-frames including a plurality of frames and generates a bitstream, the interframe wavelet video coding system comprising:
a motion estimation/mode determination block which receives the group-of-frames, obtains motion vectors of pixels in each of the frames using a predetermined procedure, and determines a mode flag using motion vectors of boundary pixels among the obtained motion vectors; and
a motion compensation temporal filtering block which decomposes the frames into low- and high-frequency frames in a predetermined temporal direction in accordance with the mode flag determined by the motion estimation/mode determination block using the motion vectors.

20. The interframe wavelet video coding system of claim 19, further comprising a spatial transform block which wavelet-decomposes the low- and high-frequency frames generated by the motion compensation temporal filtering block into spatial low- and high-frequency components.
